(19) United States
(12) Patent Application Publication
(10) Pub. No.: US 2010/0047048 A1
(43) Pub. Date: Feb. 25, 2010

(54) LIFTING LOADING PLATFORM

(75) Inventor: Martin Zimmermann, Osterholz-Scharmbeck (DE)

Correspondence Address: SMITH, GAMBRELL & RUSSELL, SUITE 3100, PROMENADE II, 1230 PEACHTREE STREET, N.E., ATLANTA, GA, 30309-3592, US

(73) Assignee: MBB PALFINGER GMBH, GANDERKESEE (DE)

(21) Appl. No.: 12/440,987

(22) PCT Filed: Aug. 28, 2007
(86) PCT No.: PCT/EP07/07501

§ 371 Date: Mar. 12, 2009

(30) Foreign Application Priority Data
Sep. 12, 2006 (DE) 10-2006-053-441.7

(51) Int. Cl. B60P 1/44; B60P 1/00

(52) U.S. Cl. 414/540

(57) ABSTRACT

Loading platforms (16) of tail lifts (13) are usually raised and lowered or pivoted by hydraulic cylinders. Hydraulic cylinders require a hydraulic unit. Furthermore, there is a risk of contamination through unsealed hydraulic lines. To raise, lower and/or pivot the loading platform (16) of the tail lift (13), the invention makes provision to use roller screw mechanisms (19) which are driven by hollow-shaft electric motors (23). As a result, hydraulic drives for the loading platform (16) are no longer required. Each roller screw mechanism (19) is driven by the hollow-shaft electric motor (23). The unit consisting of the roller screw mechanism (19) and the hollow-shaft electric motor (23) operates in principle like a known hydraulic cylinder and also has approximately the same dimensions, with the result that hydraulic cylinders can be replaced by roller screw mechanisms (19) with hollow-shaft electric motors (23) without significant modifications to the tail lift (13).

### STATEMENT OF RELATED APPLICATIONS

This application is the U.S. National Phase Under Chapter II of the Patent Cooperation Treaty (PCT) of PCT International Application No. PCT/EP2007/007501 having an International Filing Date of 28 Aug. 2007, which claims priority on German Patent Application No. 10 2006 053 441.7 having a filing date 12 Sep. 2006.

### BACKGROUND OF THE INVENTION

1. Technical Field

The invention relates to a lifting loading platform, or tail lift, for attaching to a vehicle, with a loading platform and with a lifting assembly which comprises at least one linear drive and which is intended for raising, lowering and/or pivoting the loading platform.

2. Prior Art

Tail lifts are used to facilitate the operations of loading and unloading vehicles, particularly when heavy goods are involved. Such a tail lift has a loading platform which is preferably articulated on the rear side of a body of a vehicle such that it can be raised and lowered and usually pivoted as well. The loading platform is arranged on the rear side of the body of the vehicle by means of a lifting assembly. The lifting assembly comprises at least one linear drive which causes the loading platform to be raised, lowered and/or pivoted. It is customary for the lifting assembly to comprise at least one linear drive for raising and lowering the loading platform and at least one further linear drive for pivoting the loading platform.

The linear drives of known tail lifts are designed as hydraulic cylinders. Although virtually all tail lifts have to date been provided with hydraulic cylinders for moving the loading platform, they have a major disadvantage which particularly concerns the fact that a hydraulic unit is required for operating the hydraulic cylinders and that relatively thick and bulky hydraulic hoses have to be laid from the hydraulic unit to the hydraulic cylinders. If a leak occurs in a hydraulic hose as a result of damage, for example, then oil escapes, a situation which leads to serious contamination and is also critical from an environmental point of view.

### BRIEF SUMMARY OF THE INVENTION

Taking this as the starting point, the object on which the invention is based is to provide a tail lift which has simple, cost-effective and nevertheless reliable linear drives for raising, lowering and/or pivoting the loading platform.

A tail lift for achieving this object comprises a loading platform and a lifting assembly which comprises at least one linear drive and which is intended for raising, lowering and/or pivoting the loading platform, wherein at least one linear drive comprises a roller screw mechanism. The fact that the respective linear drive comprises a roller screw mechanism makes it possible to dispense with a hydraulic unit and with the laying of hydraulic hoses, since the roller screw mechanism makes possible an electric drive, for example. By contrast with conventional linear drives, in particular screw mechanisms, the roller screw mechanism is distinguished by a smooth-running drive with low inherent friction and thus a high degree of efficiency. Consequently, a roller screw mechanism is very particularly suitable for raising, lowering and/or pivoting the loading platform of a tail lift, even when the loading platform bears heavy loads. In particular, screw mechanisms can be subjected to a high degree of loading in spite of their exceptional smooth-running properties in relation to other screw mechanisms.

Preferably, the respective roller screw mechanism comprises an axially displaceable pushrod which is provided at least partially with a roller thread. The pushrod acts like the piston rod of a hydraulic cylinder, which means that the respective roller screw mechanism can have external dimensions comparable to those of a hydraulic cylinder, with the result that it is possible without significant modifications to provide the tail lift in the manner according to the invention with roller screw mechanisms.

The roller screw mechanisms are preferably actuated electrically. Provision is made in particular for the respective roller screw mechanism to be assigned an electric motor. Each roller screw mechanism can be driven electrically in a simple manner. The power can be made available from the already present electrical system of a vehicle which, in the case of known tail lifts, serves to drive the hydraulic unit. A hydraulic unit and bulky hydraulic lines are made superfluous by the electrical drive of the roller screw mechanisms. The electrical lines can be laid easily and in the event of damage do not cause any harm as is the case with the oil loss of hydraulic cylinders or hydraulic lines.

According to one preferred embodiment, provision is made to use a hollow-shaft electric motor as the electric motor. Such a hollow-shaft electric motor is compact and specifically does not have any dimensions which are larger than those of a hydraulic cylinder which can usually be employed. The respective linear drive is then substantially formed from a roller screw mechanism and a hollow-shaft electric motor.

When the roller screw mechanism is retracted, a part, preferably a large part, of the pushrod can be retracted into the hollow-shaft electric motor, to be precise in a comparable manner to the retraction of a piston rod into a hydraulic cylinder.

Through the combination of the hollow-shaft electric motor with the roller screw mechanism, the lifting assembly for raising, lowering and/or pivoting the loading platform preferably comprises drives which approximately correspond to hydraulic cylinders in terms of their shape and their dimensions, with the result that, by virtue of the invention, no significant modifications are required to the overall design of the tail lift, in particular to the lifting assembly.

To ensure that part of the lifting rod can enter the hollow-shaft electric motor when the pushrod is completely or partially retracted, provision is made to arrange the hollow-shaft electric motor concentrically to the longitudinal center axis of the pushrod and around at least part of the latter. For that purpose, the hollow-shaft electric motor has an outer stator which is articulated on the vehicle, the lifting assembly or on the loading platform so as to be non-rotatable with respect to the longitudinal center axis of the pushrod. The hollow-shaft electric motor further has a preferably cylindrical rotor which is surrounded by the stator and which can be driven rotationally about the longitudinal center axis of the pushrod. The rotor of the hollow-shaft electric motor is thereby situated in a space-saving manner in the stator and surrounds that part of the pushrod which is retracted into the hollow-shaft electric motor. In this arrangement, the rotor can also be used in a simple manner to drive a roller screw nut of the roller screw mechanism. A rotation, produced by the rotor, of the roller screw nut about the longitudinal center axis of the pushrod results in the pushrod being displaced axially along the longitudinal center axis such that, as in the case of a hydraulic cylinder, the pushrod protrudes to a greater or lesser extent from the hollow-shaft electric motor which surrounds it.

In one preferred embodiment of the invention, provision is made for the rotor to be an integral component of the roller screw nut. This makes it possible to form a particularly compact linear drive for the lifting assembly of the tail lift. Alternatively, it is also conceivable to arrange the rotor of the hollow-shaft electric motor concentrically around the roller screw nut or to place the rotor in front of or behind the roller screw nut. In these cases, the rotor and the roller screw nut are connected to one another non-rotatably, but preferably releasably. Here, the pushrod is guided in a freely movable manner through the rotor of the hollow-shaft electric motor.

Provision is further made for the roller screw mechanism not to have a self-locking facility, that is to say the roller screw nut can be rotated, if appropriate together with the rotor, when the pushrod provided at least partially with the roller thread is subjected to axial loading. Such a roller screw mechanism is distinguished by being particularly smooth-running with low internal friction. It is thus possible for each drive according to the invention to exert relatively high lifting and/or pivoting forces on the tail gate, it also being possible in particular for the tail gate to lift heavy loads.

In order to be able to reliably lock the tail gate in the desired height or pivoting position even when it is laden with heavy loads, provision is made for each roller screw mechanism or for the hollow-shaft electric motor serving to drive said mechanism to be assigned at least one brake. The brake is preferably designed in such a way that it automatically assumes the braking position and is released, for example electromagnetically, through a supply of power. This ensures that, in the event of a power failure or an interruption in the power supply, the linear drive is locked in the instantaneous position and the loading platform cannot lower or pivot back unintentionally. It is only when the hollow-shaft electric motor is supplied with power and thereby set in operation that the brake is released, thereby ensuring that the roller screw nut is rotated and the pushrod is retracted and extended as a result. The at least one brake is preferably arranged between the roller screw nut and the stator or rotor of the hollow-shaft electric motor. This arrangement is space-saving and allows an effective engagement of the brake in order to lock the roller screw mechanism.

In a preferred tail lift, provision is made for the lifting assembly to comprise at least one roller screw mechanism with a hollow-shaft electric motor assigned thereto for selectively raising or lowering the loading platform, and at least one further roller screw mechanism with a hollow-shaft electric motor assigned thereto for pivoting the loading platform. It is possible in this way for the loading platform to be raised or lowered and pivoted by means of independent drives. If required, both drives can be moved together to simultaneously raise or lower and pivot the loading platform.

### BRIEF DESCRIPTION OF THE DRAWING FIGURES

A preferred exemplary embodiment of the tail lift according to the invention is explained in more detail below with reference to the drawing, in which:

FIG. 1 shows a perspective view of a rear part of a vehicle with a tail lift,

FIG. 2 shows a perspective view of a linear drive of the tail lift of FIG. 1, and

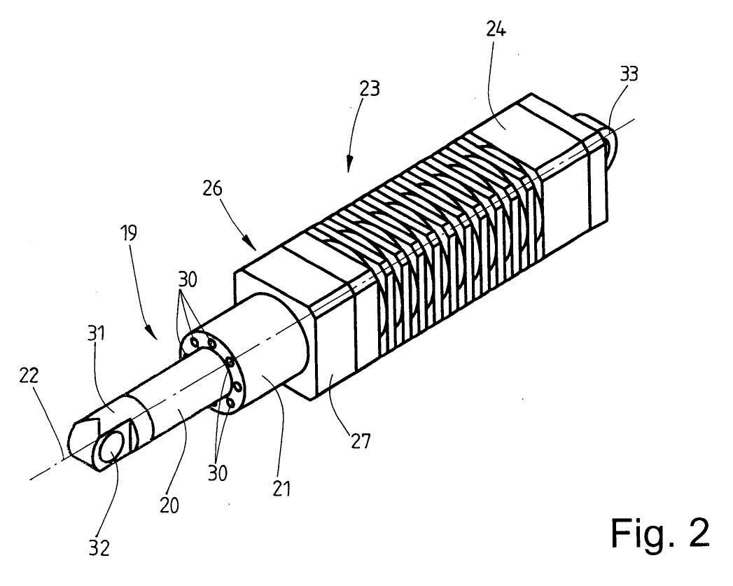

FIG. 3 shows a side view of the linear drive of FIG. 2.

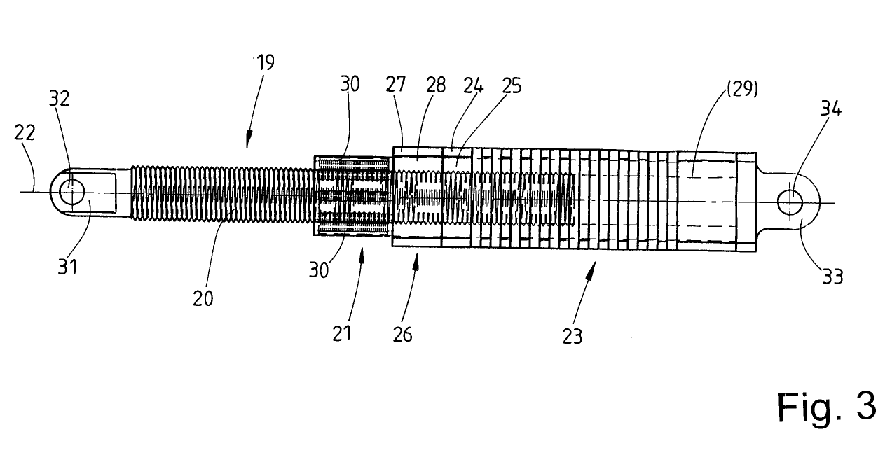

### DETAILED DESCRIPTION OF PREFERRED EMBODIMENTS

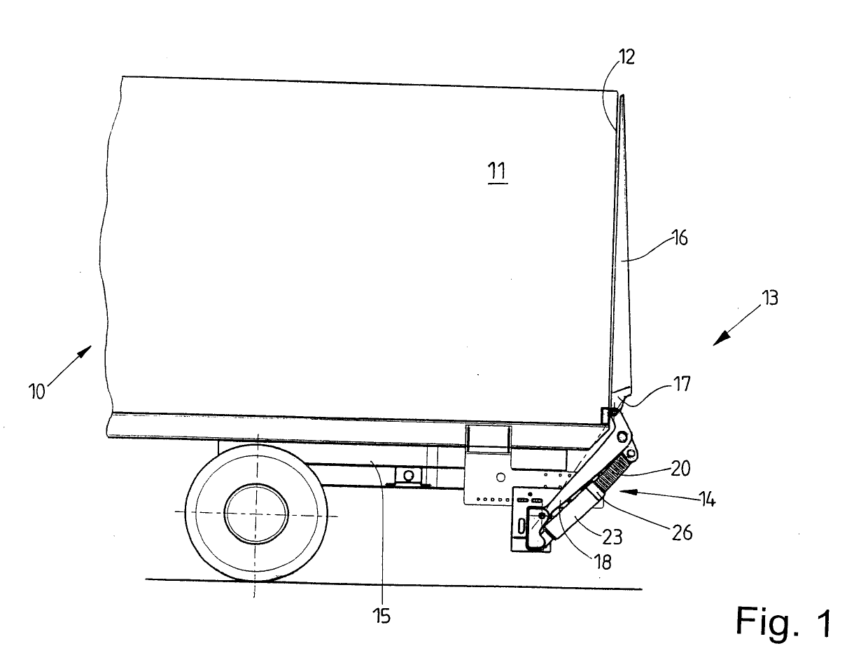

FIG. 1 shows a rear part of a vehicle, specifically a truck 10. The truck 10 has a body 11 which, in the exemplary embodiment shown, is a so-called box body. The body 11 has a rear side 12 which is at least partially open or which is to be opened. The rear side 12 can preferably be opened or closed by means of doors or the like.

The rear side 12 of the truck 10 is assigned the tail lift 13 according to the invention. The tail lift 13 has a lifting assembly 14 which is directly or indirectly fastened by means of a transversely directed support tube to a vehicle frame 15 of the truck 10, this frame being represented only by way of an outline in FIG. 1. The tail lift 13 also has a loading platform 16. The loading platform 16 is articulated on the lifting assembly 14 so as to be able to pivot on a lower (in relation to the representation in FIG. 1) transverse edge 17. The loading platform 16 can additionally be lowered and raised by the lifting assembly 14. FIG. 1 shows the closed position of the tail lift 13, in which position the loading platform 16 is lifted up by the lifting assembly 14 and pivoted into a vertical position behind the body 11 of the truck 10. When the truck 10 is in a position of movement, the loading platform 16 is thus situated completely behind the body 11.

The lifting assembly 14, which is represented only in part in FIG. 1, comprises two identical link arms 18 which can move synchronously in parallel vertical planes. The link arms 18 can be interconnected by means, for example, of a tube or a beam. The lifting assembly 14 comprises linear drives which serve to pivot the loading platform 16 with respect to the lifting assembly 14 and to raise and lower the lifting assembly 14 together with the loading platform 16 fastened thereon. Depending on the particular load-bearing capacity of the tail lift 13 and/or its design, it is possible to provide one or two linear drives for pivoting the loading platform 16 or likewise one or two linear drives for raising and lowering the loading platform 16. In the case of the tail lift 13 shown (FIG. 1), only a single linear drive for pivoting the loading platform 16 and a single linear drive for raising and lowering the lifting assembly 14 together with the loading platform 16 are provided. FIG. 1 shows a linear drive. For example, this can be the linear drive for pivoting the loading platform 16. With respect to the view in FIG. 1, and concealed behind the latter, the second linear drive for raising and lowering the loading platform 16 is preferably arranged on another side of the lifting assembly 14.

According to the invention, each of the identically designed linear drives comprises a roller screw mechanism 19. The roller screw mechanism 19 has an elongate pushrod 20, which is provided at least partially with a roller thread, and a roller screw nut 21 surrounding the pushrod 20 over a region thereof. The pushrod 20 of the roller screw mechanism 19 is non-rotatably connected to the vehicle frame 15, the lifting assembly 14 or the loading platform 16. On the pushrod 20, specifically the roller thread thereof, the roller screw nut 21, which is arranged concentrically about the pushrod 20, can be rotated about a longitudinal center axis 22 of the pushrod 20. As a result, the pushrod 20 is axially displaced in the direction of its longitudinal center axis 22 with respect to the roller screw nut 21. There are various possible ways of driving the roller screw mechanism 19, specifically of rotating the roller screw nut 21. In the preferred exemplary embodiment of the invention that is shown, the roller screw nut 21 is driven by an electric motor, i.e. rotated about the longitudinal center axis 22 of the pushrod 20. For this purpose, in the preferred exemplary embodiment of the invention that is shown here, the roller screw mechanism 19 is assigned an electric motor, to be precise preferably a hollow-shaft electric motor 23. In the preferred exemplary embodiment of the invention, each of the identical linear drives thus comprises a roller screw mechanism 19 and a hollow-shaft electric motor 23.

The hollow-shaft electric motor 23 and the roller screw mechanism 19 are arranged coaxially one behind the other, with the result that the roller screw mechanism 19 and the hollow-shaft electric motor 23 lie on the same axis, specifically the longitudinal center axis 22 of the pushrod 20. Because the roller screw mechanism 19, which serves to form the linear drive according to the invention, and the hollow-shaft electric motor 23 are situated coaxially one behind the other, the linear drive according to the invention has a shape which corresponds to that of the hydraulic cylinders which have been conventionally used to date. In this respect, the hollow-shaft electric motor 23 can be considered to be the cylinder of the hydraulic cylinder, while the pushrod 20 of the roller screw mechanism 19 corresponds to the piston rod of a hydraulic cylinder.

The hollow-shaft electric motor 23 has an outer stator 24 which is non-rotatably connected to the vehicle frame 15, the support tube, the lifting assembly 14 or the loading platform 16. The stator 24 has a cylindrical cavity which is open on one side and in which a cylindrical rotor 25 is situated in a rotatable manner. The hollow-shaft electric motor 23 is assigned a brake 26 which is arranged in front of that end of the hollow-shaft electric motor 23 which faces the pushrod 20. Connected to the brake 26 in turn is the roller screw nut 21. In the exemplary embodiment of the invention that is shown, the brake 26 is thus arranged between the hollow-shaft electric motor 23 and the roller screw nut 21.

The brake 26 has a fixed outer part 27 which cannot be rotated about the longitudinal center axis 22 and which is connected to the stator 24 of the hollow-shaft electric motor 23, specifically fastened in front of the stator 24, by the outer part 27 of the brake 26 and the stator 24 of the hollow-shaft electric motor 23 being screwed together, for example, at their mutually directed end faces. Situated coaxially in the outer part 27 of the brake 26 is an inner part 28 thereof which is non-rotatably connected to the roller screw nut 21 by the inner part 28 of the brake 26 and the roller screw nut 21 of the roller screw mechanism 19 being preferably screwed together at their mutually directed end faces. Moreover, the inner part 28 of the brake 26 is non-rotatably connected to the end face of the rotor 25 of the hollow-shaft electric motor 23. The rotor 25 of the hollow-shaft electric motor 23, the inner part 28 of the brake 26 and the roller screw nut 21 are thus connected to form a unit whose parts cannot rotate relative to one another.

When the brake 26 is released, the roller screw nut 21 can be rotationally driven about the longitudinal center axis 22 of the pushrod 20 by the rotationally driven rotor 25 of the hollow-shaft electric motor 23 via the inner part 28, which is rotatable therewith, of the brake 26. As a result of the roller screw nut 21 being rotationally driven about the non-rotatable pushrod 20, said pushrod is extended or retracted depending on the direction of rotation of the roller screw nut 21, and consequently the length of the roller screw mechanism 19 is increased or shortened. That part of the pushrod 20 by which the length thereof is shortened with respect to the roller screw nut 21 is accommodated inside the hollow-shaft electric motor 23. For this purpose, the rotor 25 of the hollow-shaft electric motor 23 is provided with a cylindrical passage 29 whose inside diameter is slightly larger than the maximum outside diameter of the threaded portion of the pushrod 20. The same applies to the inner part 28 of the brake 26. By contrast, the roller screw nut 21 is in threaded engagement with the external thread of the pushrod 20. For this purpose, a plurality of elongate threaded rollers 30 having a relatively small diameter are distributed over the inner circumference of the roller screw nut 21. The threaded rollers 30 have a continuous external thread which is designed to correspond with the roller thread on the outer circumference of the pushrod 20, with the result that the thread of the threaded rollers 30 meshes with the thread of the pushrod 20. By rotating the roller screw nut 21, the threaded rollers 30 are also rotated about their longitudinal axes which extend parallel to the longitudinal center axis 22 of the pushrod 20, and in so doing the pushrod 20 is moved axially through the roller screw nut 21, specifically into or out of the hollow-shaft electric motor 23 depending on the direction of rotation of the roller screw nut 21.

The free end of the pushrod 20 that is directed away from the hollow-shaft electric motor 23 is designed as a fastening end 31 which is provided with a transversely directed through-hole 32. Hence, the pushrod 20 is connected non-rotatably but in an articulated manner to the loading platform 16 or to the lifting assembly 14, specifically to the free end which faces the loading platform 16. Likewise, the stator 24 of the hollow-shaft electric motor 23 is provided at its side facing away from the pushrod 20 with a fastening end 33 which also has a through-hole 34. The fastening end 33 is used to connect the hollow-shaft electric motor 23 non-rotatably but in an articulated manner to a bearing bracket for the lifting assembly 14 on the vehicle frame 15, in particular the support tube.

The linear drive shown here comprises the brake 26 because the roller screw mechanism 19 is designed not to be self-locking. Consequently, when loading the loading platform 16, in particular with a relatively large load, the resulting application of an axial force to the pushrod 20 causes the roller screw nut 21 to rotate. In order to prevent this and thus reliably lock, the loading platform 16 in the set height and inclination, the roller screw nut 21 is prevented from an unwanted rotation by the brake 26. For this purpose, the brake 26 must only apply a relatively small braking force since only a relatively small force acts in the circumferential direction of the roller screw nut 21. Consequently, only a small braking force is required in order to prevent an automatic change in the length of the roller screw mechanism 19 when the loading platform 16 is loaded with heavy goods.

The brake 26 is preferably designed in such a way that it brakes and thus non-rotatably maintains the roller screw nut 21 and/or the rotor 25 of the hollow-shaft drum motor 23 if no power is available at the brake 26 to actuate it. It is only when the brake 26 is disengaged, for example electrically, that it frees the roller screw nut 21 to rotate, with the result that the roller screw nut 21 can then be rotated on the pushrod 20 by the hollow-shaft electric motor 23 in order to change the length of the roller screw mechanism 19, thus leading to the loading platform 16 of the tail lift 13 being correspondingly pivoted and/or raised or lowered.

The brake 26 is preferably actuated electrically; however, it can also be actuated in other ways, for example pneumatically or mechanically.

An electric brake 26 has the advantage that, when the hollow-shaft electric motor 23 is supplied with electric power in order to change the length of the pushrod 20, the brake 26 is also supplied with electric power, and hence the brake 26 is disengaged and the rotor 25 of the hollow-shaft electric motor 23 can rotationally drive the roller screw nut 21. As a result, and depending on the particular direction of rotation of the hollow-shaft electric motor 23, the pushrod 20 is either pushed further along the longitudinal center axis 22 into the cylindrical passage 29 in the rotor 25 of the hollow-shaft electric motor 23 or moved out of the passage in the rotor 25 of the hollow-shaft electric motor 23. If the rotation of the rotor 25 of the hollow-shaft electric motor 23 is halted due to an interruption in the power supply, this leads to the brake 26 being locked automatically, whereby the roller screw nut 21 is immobilized against rotation, and as a result, even when the loading platform 16 of the tail lift 13 is loaded, the pushrod 20 of the roller screw mechanism 19 cannot be unintentionally retracted into or extended out from the hollow-shaft electric motor, and, consequently, the respective length of the linear drive according to the invention cannot be changed.

### List of Reference Numbers

10 truck
11 body
12 rear side
13 tail lift
14 lifting assembly
15 vehicle frame
16 loading platform
17 transverse edge
18 link arm
19 roller screw mechanism
20 pushrod
21 roller screw nut
22 longitudinal center axis
23 hollow-shaft electric motor
24 stator
25 rotor
26 brake
27 outer part
28 inner part
29 passage
30 threaded roller
31 fastening end
32 through-hole
33 fastening end
34 through-hole

What is claimed is:

1. A tail lift for attaching to a vehicle, with a loading platform (16) and with a lifting assembly (14) which comprises at least one linear drive and which is intended for raising, lowering and/or pivoting the loading platform (16), wherein the at least one linear drive comprises a roller screw mechanism (19).

2. The tail lift as claimed in claim 1, wherein the respective roller screw mechanism (19) comprises an axially displaceable pushrod (20) which is provided at least partially with a roller thread.

3. The tail lift as claimed in claim 1, wherein the roller screw mechanism (19) is driven electrically.

4. The tail lift as claimed in claim 1, wherein the respective roller screw mechanism is driven electrically by an electric motor, and the respective linear drive comprises the roller screw mechanism (19) and the electric motor which drives said mechanism.

5. The tail lift as claimed in claim 4, wherein the respective electric motor is a hollow-shaft electric motor (23).

6. The tail lift as claimed in claim 5, wherein the hollow-shaft electric motor (23) is arranged concentrically to a longitudinal center axis (22) of the pushrod (20) of the roller screw mechanism (19) and around at least part of the pushrod (20).

7. The tail lift as claimed in claim 6, wherein the hollow-shaft electric motor (23) comprises an outer stator (24) which is mounted on the vehicle, the lifting assembly (14) and/or the loading platform (16) so as to be non-rotatable with respect to the longitudinal center axis (22) of the pushrod (20)

8. The tail lift as claimed claim 7, wherein the hollow-shaft electric motor (23) comprises a cylindrical rotor (25) which is surrounded by the stator (24), wherein the rotor (25) is rotationally driven about the longitudinal center axis (22) of the pushrod (20).

9. The tail lift as claimed in claim 8, wherein the rotor (25) of the hollow-shaft electric motor (23) rotationally drives a roller screw nut (21) of the roller screw mechanism (19) about the longitudinal center axis (22) of the pushrod (20).

10. The tail lift as claimed in claim 9, wherein the rotor (25) is an integral component of the roller screw nut (21).

11. The tail lift as claimed in claim 10, wherein the rotor (25) is directly or indirectly connected to the roller screw nut (21), wherein the roller screw nut (21) is located coaxially in front of the rotor (25).

12. The tail lift as claimed in claim 11, wherein part of the pushrod (20) is freely movable, in a passage (29) of the rotor (25), and part of the pushrod (20) can be accommodated in the passage (29) of the rotor (25).

13. The tail lift as claimed in claim 6, wherein a free actuating end 31 of the pushrod (20) is articulated on the lifting assembly (14) or the loading platform (16) so as to be non-rotatable about the longitudinal center axis (22).

14. The tail lift as claimed in claim 1, wherein the respective roller screw mechanism (19) is designed not to be self-locking, the roller screw nut (21), which is in meshing engagement with the external roller thread of the pushrod (20), preferably being rotatable through an axial movement of said pushrod.

15. The tail lift as claimed in claim 9, wherein the respective roller screw mechanism (19) and/or the hollow-shaft electric motor (23) respectively assigned thereto is assigned at least one brake (26), which automatically assumes the braking position and which is releasable electrically.

16. The tail lift as claimed in claim 5, wherein the brake (26) is arranged between the roller screw nut (21) of the roller screw mechanism (19) and the hollow-shaft electric motor (23).

17. The tail lift as claimed in claim 5, wherein the lifting assembly (14) comprises at least one roller screw mechanism (19) with a hollow-shaft electric motor (23) assigned thereto for selectively raising or lowering the loading platform (16), and at least one further roller screw mechanism (19) with a hollow-shaft motor (23) assigned thereto for pivoting the loading platform (16).
